(19) United States
(12) Patent Application Publication
(10) Pub. No.: US 2002/0075506 A1
(43) Pub. Date: Jun. 20, 2002

(54) Remote printing of electronic mail

(75) Inventors: Duncan I. Stevenson, Smallford (GB); Michael J. Lovibond, Kimpton (GB); Garry Blackmore, Stevenage (GB)

Correspondence Address: John E. Beck, Xerox Corporation, Xerox Square 20A, Rochester, NY, 14644, US

(73) Assignee: Xerox Corporation

(21) Appl. No.: 09/738,924

(22) Filed: Dec. 15, 2000

(51) Int. Cl. G06F 15/00; B41F 1/00

(52) U.S. Cl. 358/1.15; 358/1.14

(57) ABSTRACT

A digital printer which resides on a network is, by itself, capable of accessing an electronic mail account which exists in an SMTP server on the same network. The user interface of the printer can be used to enter a network password and view headings of messages in the account associated with the network password. The user can then request the text or attachments of certain messages to be output at the printer. The system allows any user who has access to the network to retrieve electronic mail without a personal computer.

### FIELD OF THE INVENTION

The present invention relates to digital printing apparatus, particularly those which exist on a network having electronic mail (e-mail) capability.

### BACKGROUND OF THE INVENTION

Digital printing apparatus, devices which receive digital image data and output hard copy sheets based on the digital image data, are well known. It is also familiar to locate such printers on a network, so that one or more printers can receive image data from any number of computers on the network for printing. The computers, or other image sources such as scanners, can convey data representative of images desired to be printed over the network, using familiar techniques such as Ethernet, Internet, or other protocols.

Since digital printers exist on a network which is shared with any number of personal computers or other devices, the digital printers form an integral part of a corporate wide network which can exist among several offices, and indeed among several countries or continents. It is conceivable, for instance, to send a print job from a computer in the United States to a printer in England; if the computer and printer are part of a single corporate entity organized with a single corporate authentication server, the transaction is indistinguishable from sending the print job from one side of a room to the other. Typically, after an initial authentication of the computer, an authentication server controlling the entire network will simply allow transparent access to any other device on the network, including a printer which may be located in another country.

The present invention relates to a system whereby software which is hosted on a particular printer enables remote access to electronic mail accounts by any authenticated person recognized by the network, so that the person's electronic mail messages may be printed out at the printer without, for instance, the use of a personal computer.

### DESCRIPTION OF THE PRIOR ART

U.S. Pat. No. 5,760,917 discloses a distribution system for transmission of digital images. There is provided a hub station and terminals remote from the hub station. Each terminal includes means for selecting access rights to a remotely stored image set.

U.S. Pat. No. 6,078,406 discloses a system for controlling transmission of information relating to print jobs. Data relating to a print job is sent to a printer. Information relating to the confirmation or failure of the print job can be sent to any number of confirmation destinations via electronic mail.

U.S. Pat. No. 6,108,099 discloses a printer having a network interface for connecting the printer to network as a network terminal, and an electronic mail communication control unit for communicating with another network terminal. Abnormal conditions which are sensed within the printer result in specialized electronic mail communications to a particular address.

### SUMMARY OF THE INVENTION

According to the present invention, there is provided a digital printing apparatus, comprising a print engine, for outputting prints in response to printer-formatted digital data submitted thereto, and an electronic mail client. Access means cause the electronic mail client to access an electronic mail account in an electronic mail server, and transfer data derived from at least one electronic mail message stored in the electronic mail account to the print engine.

### BRIEF DESCRIPTION OF THE DRAWINGS

FIG. 1 is a diagram showing a plurality of digital printers operatively disposed on a network, illustrating a context of the present invention.

FIG. 2 is a diagram showing the elements of a digital printer suitable for carrying out the present invention.

### DETAILED DESCRIPTION OF THE INVENTION

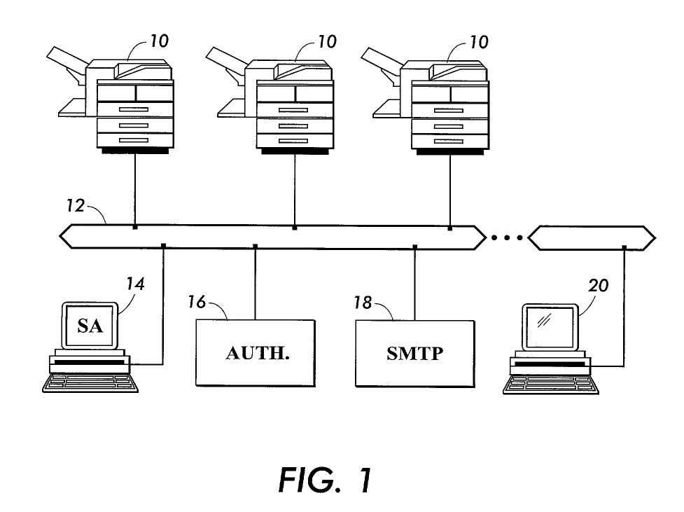

FIG. 1 is a diagram showing the configuration of a plurality of digital printers, each of which is indicated as 10, operatively disposed on a network, such as indicated as 12. The network 12 is of a type familiar for applications in both transmission of print jobs and electronic mail, and such networks are common in any number of business organizations. Typically disposed on such a network is a computer relating to a systems administrator (SA), and such computer is indicated in FIG. 1 as 14; there will also be disposed on network 12 what is called an “authentication server” 16 as well as an electronic mail or SMTP server 18. In addition, there will typically be provided on the network 12 any number of a personal computers or their equivalents, one of which is indicated as 20. In a common configuration of such networks in business organizations, these computers such as 20 can exist in several rooms, several buildings, or across countries.

The function of the authentication server 16, which is typically controlled via the systems administrator computer 14, is to “authenticate” individual users, each of which is in control of a particular computer 20. Typically, a user who has logged onto one computer 20 can submit a network password to the authentication server 16, and if the password is correct, the person on computer 20 will thus be granted access, through authentication server 16, to other devices on network 12. Among these other devices on network 12 is the SMTP server 18, which, as is well known, typically serves as a common repository for the electronic mail accounts of all persons on the network.

With reference to the individual printing devices on network 12, which are each indicated as 10, each of these printers includes at least a print engine, meaning a xerographic, ink-jet, or equivalent device, by which digital data representative of images desired to be printed are caused to create marks on sheets which are output by each printer 10. Further, each printer 10 can in fact be a multifunction device, such as including an input scanner so as to function as a digital copier: further functions such as facsimile and scan-to-file are common in such machines as well.

With particular reference to the present invention, there is provided, within each printing apparatus 10, hardware and software which enables the printer itself to act as a device on network 12 which is capable of accessing other sources of data on a network, in particular, electronic mail accounts within one or more SMTP servers 18 on the network. In other words, according to the present invention, a person desiring to access his own electronic mail account on a server 18 would be able to walk up to a printer 10 which has been specially equipped according to the present invention, and, using the printer alone and without an additional personal computer, access the electronic mail messages in his account.

The practical advantage of the present invention is as follows. If a person working for a particular company is traveling to various locations within the company, and is away from his own personal computer such as 20, that person can go to any printer or digital copier which is on the corporate network, and, simply by entering his standard network password, remotely access and print out his electronic mail. The same concept could apply to a printer or digital copier in a semi-public context, such as in a university library, wherein, in addition to walkup use of the digital copier, registered users such as students can use the copier to retrieve their electronic mail on a university-sponsored server, perhaps printing out attachments therein after submitting a fee, either with currency or a debit card.

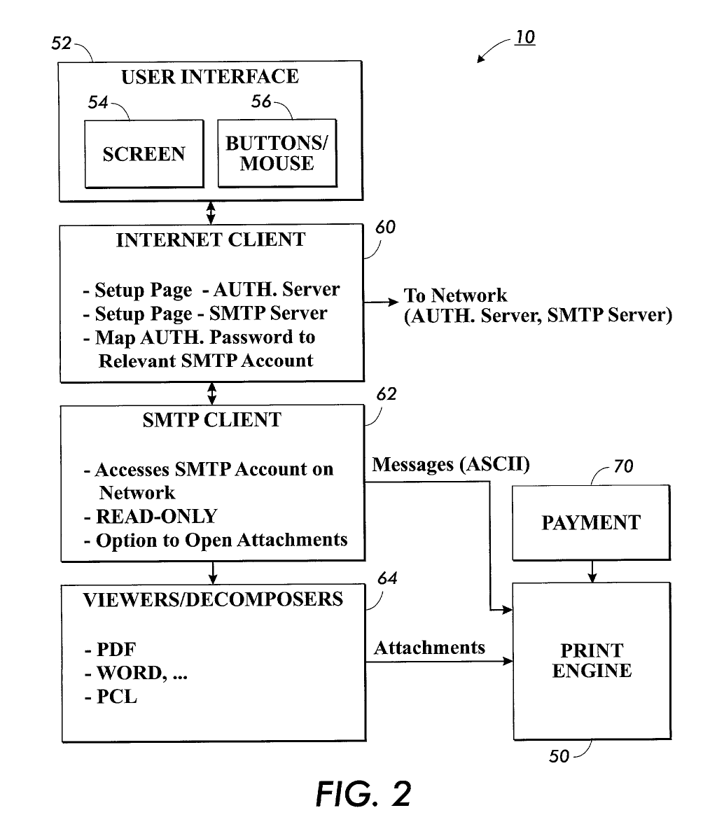

FIG. 2 is a simplified diagram showing the essential elements, which are embodied in a software and hardware, which must be incorporated within a particular printer 10 in order for the printer to carry out the essential functions of the present invention. In the below description, each of the elements are known in the prior art, or could be readily adapted using well-known principles of Internet communication.

As mentioned above, an essential attribute of any printing apparatus 10 is a print engine, which may be of any type familiar in the art, such as an ink jet engine or a xerographic “laser” engine. Ancillary to the basic hardware is software which formats, buffers, and otherwise processes image data for submission to the hardware. The print engine, along with any associated software, is generally indicated in the Figure as 50.

Another element of a printer 10 which is important to the present invention is what can be called a “user interface” 52. User interfaces, which typically comprise a touch screen, lighted display, or similar device, are generally familiar in the art of copiers and printers. With particular reference to the present invention, there should be at least two essential attributes of the user interface 52, which are shown separately in the Figure for clarity: there should be a display screen 54, by which information is displayed to a user, as well as some manually operable device, such as indicated as buttons 56. It will be noted that the functions of the display screen 54 and buttons 56 may, in a practical embodiment, be combined in a single structure, such as a touch-sensitive screen, and can include more sophisticated devices, such as a mouse, joystick, or QWERTY keyboard, depending on the relative sophistication and cost of the printer 10. What is important is that a certain quantity of information be readily displayed to the human user, and that the human user can in turn implement his desired instructions for the user interface easily and accurately. As is well known, the user interface generally indicated as 52 includes not only the display and button hardware but ancillary software as well: indeed, in one typical implementation of the user interface, the user interface 52 itself includes a dedicated microprocessor. In a preferred embodiment of the present invention, user interface 52 is the same user interface (i.e., the same display screen) as is used for general functions of printer 10, such as for selecting finishing, paper supply, and other options, particularly if printer 10 is a digital copier: in the language of the claims, the user interface 52 can be used both for the basic purposes of the invention and also for “selecting printer related options.”

Besides the print engine 50 and the user interface 52, along with any other functions which are native to the basic printing apparatus 10, there are further special elements which enable the present invention. Foremost among these elements are an Internet client 60, and an SMTP client 62. In general, these “clients” are software entities which run on a one or more microprocessors within printer 10: in general, such clients are commercially available, and indeed, for present purposes, may exist as “defeatured” versions of commercially available products. Significantly, these elements such as 60 or 62 are “hosted” by the basic hardware of the printer 10: they run on processors which are integrated with the overall control system of printer 10.

First, with regard to Internet client 60, there are essentially two modifications which must be made to the basic client in order for it to operate according the present invention: there must be set up on client 60 a page referencing the Internet address of the authentication server 16 (as shown in FIG. 1), as well as another page referencing the Internet address of one or more SMTP servers 18 which would be required to be referenced by a human user likely to be using a particular printer 10. In other words, with the set up pages, the Internet client 60 is loaded with the information about where the relevant authentication server 16 and SMTP server 18 reside. With regard to SMTP client 62, the essential function of this client is to access an authorized account in the SMTP server 18 out on the network, and then to view, preferably in a “read-only” fashion, message headings and text from electronic mail messages in that account. As such, the SMTP client 62 may simply be a defeatured, read-only version of any number of commercial electronic mail clients, such as Microsoft® Outlook™. The client 62 should be capable of, for example, discriminating between open and unopened mail in an electronic mail inbox, as well as indicating whether an attachment to the particular electronic mail message exists, and making available an option to access and open such attachments. Once again, all these basic capabilities are available through commercial electronic mail programs, and indeed, the client 62 required to carry out this invention can probably be a rudimentary version of such a commercial program.

Having discussed the basic elements of a digital printing apparatus which facilitates the present invention, a preferred method of operation of the present invention is as follows. A user having some relationship to a corporate-wide network, such as by being an employee, may wish to access his electronic mail messages, which are located in an SMTP server 18 somewhere on the network. However, if the user is not disposed near his customary personal computer, he can nonetheless go to a printing apparatus such as printer 10 which is on the network, in order to access his messages. For this purpose, according to the present invention, there should be, in user interface 52, provision for the user to select a mode of operation such as “retrieve electronic mail.” Once this option has been selected, such as through a touch screen, the user is asked to identify himself by name or other identifier, and then to enter his network password, which would preferably be the same network password the user would use when logging on to his personal computer 20. As a practical matter, if the user is one of thousands of people sharing a network within a large corporation, it may be desirable to have the user enter this information through a standard QWERTY keyboard which is associated with the digital printing apparatus (such a keypad may be embodied on a touchscreen). After he has been identified, the user enters a password, such as on the QWERTY keypad. Practical variations on the above described methods of entering personal information into a printing apparatus will be appreciated.

According to a preferred embodiment of the present invention a single network login will be required to gain access to the e-mail service. When the user enters his name, and then enters his standard network password, the Internet client 60 within printer 10 can simultaneously obtain authorization from authentication server 16, which grants the user access to the network in general, and also to the SMTP server 18, which will provide the particular user with access to his electronic mail account, without the user having to enter a separate password for electronic mail. In this way, the network login procedures and password for a user logging into the network simultaneously map into an electronic mail account accessible to the user.

Once communication is established between a particular printing apparatus 10 and the SMTP server 18, the SMTP client 62 within the printer 10 can then view the contents of the user's electronic mail account, exactly in the manner of a commercial e-mail program. Such commercial programs would be capable of distinguishing between opened and unopened messages. Thus, from the perspective of the user interface 52, the user standing at the particular printer can be offered the option of viewing or printing all of his electronic mail messages, or only those which are unopened: this option can be presented to the user as a simple pair of buttons, such as on a touch screen. Another possible standard for choosing what messages to view or print is to allow the user to select viewing or printing of only those messages in which the user is one of small number of recipients; this would exclude messages sent to large distribution lists.

Once the user selects what type of messages he would like to view, the electronic mail client 62 within printer 10 can then view the requested messages in the particular account. The text of the messages is, according to the present invention, sent directly to the print engine 50. Typically, the basic text of the electronic mail messages will be in a simple ASCII text format, and such text formats are easily fed to the print engine 50 for printing. Thus, once the user selects the messages in his account he wishes to view, the ASCII data forming the messages can be fed readily to the print engine 50 with only minimal formatting. Typically, it is probably most desirable to simply print each message on successive sheets of paper (one message per page or otherwise) which are output by the print engine 50.

Another possibility is to have only the headings (sender, subject, etc.) for the desired messages appear on the screen 54 of the user interface 52, so that the user can view the headings and then select, such as through buttons 56, specific messages in his inbox which he would like to print out with the printer 10. Typically, for cost reasons, the screen 54 in a printer 10 is small, so that displaying an entire e-mail message through screen 54 is probably not practical.

It is common, in commercial contexts of electronic mail, that certain messages will include attachments which link to longer communications, such as long prose documents or spreadsheets. Typically, these attachments within an electronic mail must link to another location in the basic electronic mail memory or a separate memory. A facility for opening attachments is common in many commercial electronic mail applications. With the present invention, such attachments can be viewed using, for example, a viewer for such attachments such as shown at 64 in FIG. 2. These viewers can be resident within a particular printer 10, or at the printer can can remotely access the viewer from another source. Such viewers which would be useful in this context include Microsoft®Word™, Microsoft® Excel™, WordPerfect®, and so forth; and can also include decomposers for printing, such as Adobe® Acrobat™ or PCL (indeed, such decomposers are standard in most digital printers). For purposes of the present invention, the definition of a viewer is whatever software is necessary to make an attachment residing in an electronic mail memory printable by the print engine 50.

In a practical embodiment of a printing apparatus which is capable of remotely viewing and printing out attachments in electronic mail, it is probably most useful to display to the user the headings of various messages through screen 54, and, along with the display of the sender and subject heading, provide some symbolic indication of whether an attachment is provided with the message: once again, this capability of showing the presence of an attachment is present in, for example, Microsoft® Outlook™. When the headings are displayed on screen 54, there can further be displayed some other indication available to the human user that he may select to print out that particular attachment. If the user uses buttons 56 or equivalent to indicate that a message displayed on screen 54 should have its attachment printed, then the attachment can be viewed from the SMTP server 18, the attachment data sent through the suitable viewer or decomposer 64, and printed through print engine 50.

Another conceivable technique for facilitating selection of what attachments in an electronic mail account to be printed out can include deriving and printing bar codes or their equivalent on the printout of the basic electronic mail messages, allowing a user to indicate, such as with a check mark on the actual printed sheet, what attachments he would like to print out. Then the user can feed the marked printout through an input scanner, such as on a digital copier, and special software within the digital copier could interpret the bar codes and marks as instructions to print out a particular attachment. Such a functionality could be adapted from existing commercial input scanning products, such as Xerox® FlowPort®.

In a commercial or library context of a printer such as 10, it may be desirable to include a payment device, such as indicted in FIG. 2 as 70, associated with the print engine 50. Thus, in for instance a university library context, a registered student recognized by the network will be able to access his own electronic mail account via a printer 10 in the library, but would have to pay a per-page fee for printing of any output (either the basic electronic mail messages, or a particular attachment thereto) at the library's printer. Such a payment device 70 could accept currency or other payment means, such as a debit card. The basic technology for such a payment device associated with a print engine is known.

Although the authentication server 16 and SMTP server 18 are each shown in FIG. 1 as an independent computer residing on a network 12, and indeed are preferred to be such as of the filing hereof, it is conceivable that any of these servers could be combined in a single computer, or could be hosted by a processor within a printer 10 on the network: in other words, if a particular printer 10 is “always on” in the manner of a server (as is often the case with high-volume printers), it may be desirable to use the processor in the printer as a server for any of the above functions.

1. A digital printing apparatus, comprising:
a print engine, for outputting prints in response to printer-formatted digital data submitted thereto;
an electronic mail client; and
access means for causing the electronic mail client to access an electronic mail account in an electronic mail server, and transfer data derived from at least one electronic mail message stored in the electronic mail account to the print engine.

2. The apparatus of claim 1, the access means including a client which is hosted by a processor within the digital printing apparatus.

3. The apparatus of claim 1, further comprising a viewer for submitting an attachment associated with the electronic mail message to the print engine as printer-formatted digital data.

4. The apparatus of claim 1, further comprising authentication means for authenticating the electronic mail client relative to the electronic mail server of interest.

5. The apparatus of claim 4, further comprising means for mapping a user's network password to an electronic mail account accessible to the user.

6. The apparatus of claim 1, further comprising a user interface for displaying headings of electronic mail messages in the electronic mail account.

7. The apparatus of claim 6, the user interface being further usable for selecting printer-related functions.

8. The apparatus of claim 1, further comprising a user interface including means for allowing a user to select a displayed electronic mail message for printing.

9. The apparatus of claim 1, further comprising a user interface including means for allowing a user to select printing an attachment associated with a message in the electronic mail account.

10. The apparatus of claim 1, further comprising a payment device for accepting payment for the print engine printing the electronic mail message.

11. The apparatus of claim 1, further comprising a payment device for accepting payment for the print engine printing an attachment associated with an electronic mail message.
